(19) United States
(12) Patent Application Publication
(10) Pub. No.: US 2007/0107854 A1
(43) Pub. Date: May 17, 2007

(54) OPERATING SYSTEM FOR COLLAPSIBLE COVERING FOR ARCHITECTURAL OPENINGS

(75) Inventor: Ralph G. Jelic, Boulder, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 11/560,072

(22) Filed: Nov. 15, 2006

Related U.S. Application Data
(60) Provisional application No. 60/737,166, filed on Nov. 16, 2005.

(51) Int. Cl. E06B 9/30

(52) U.S. Cl. 160/170

(57) ABSTRACT

An operating system for a vertically movable collapsible covering includes lift cords anchored at an upper end to the top rail for the covering and at the bottom end on wrap spools which are either driven by coil springs or a reversible motor. The coil springs and motor via its transmission help counterbalance the shade so that it can be supported at intermediate positions between fully retracted and fully extended positions of the covering and lift cord guide pins are provided around which the lift cords can be wrapped to obtain a desired amount of friction to assist in rendering the covering counterbalanced regardless of the size and weight of the covering. The control system is confined within a dummy vane at the bottom of the fabric for the covering so as to be hidden from view.

### CROSS REFERENCE TO RELATED APPLICATION

The present application claims the benefit under 35 U.S.C. § 119(e) to U.S. Provisional Patent Application No. 60/737,166 (“the '166 application”), which was filed on Nov. 16, 2005, and entitled Operating System for Collapsible Covering for Architectural Openings.” The '166 application is incorporated by reference into the present application in its entirety.

### BACKGROUND OF THE INVENTION

1. Field of the Invention

The present invention relates generally to operating systems for coverings for architectural openings and more specifically to an operating system for a vertically movable collapsible shade which is counterbalanced so as to be removably positionable at any location between fully extended and retracted positions. The system is modular and can be manually or electrically operated.

2. Description of the Relevant Art

Coverings for architectural openings have been in use for many years with some coverings being static and typically more decorative while others are retractable so as to perform both an aesthetic and functional role. Retractable coverings can be vertically movable or horizontally movable between extended and retracted positions relative to the architectural opening. In the case of vertically movable retractable coverings, the weight of the shade becomes a factor and, accordingly, counterbalanced systems have been developed so that the shade is easily movable between extended and retracted positions and will remain in any selected position therebetween. Motor driven coverings have also been developed and are particularly useful with remote architectural openings which are not easily accessible and therefore manual operation of the covering becomes a problem.

Improvements in operating systems for retractable coverings for architectural openings are continually being made and it is to provide such an improvement that the present invention has been developed.

### SUMMARY OF THE INVENTION

The present invention relates to a control system for a vertically movable, collapsible covering for architectural openings. The system includes a top rail connected to the framework around the architectural opening with mounting brackets, a bottom rail containing the operative components of the operating system, a collapsible shade or fabric extending between the top and bottom rails, and a plurality of lift cords anchored at their upper ends to the top rail and to the operating system within the bottom rail at their lower ends.

The operating system includes a wrap spool for each lift cord and a system for rotating the wrap spools in a predetermined direction so as to cause the lift cords to be wrapped on the wrap spools when the covering is retracted. The spools can be rotated either by coil springs or by an electric motor with the coil springs or motor being modular units and interchangeable. The coil springs or the electric motor provide assistance in counterbalancing the covering so that it can be removably positioned at any location between fully extended and retracted positions. A plurality of guide pins are also provided in the bottom rail and form a part of the operating system with the lift cords being passed in selected circuitous paths around the guide pins to establish selected frictional resistance to movement of the shade so that the counterbalancing of the shade can be regulated depending upon the size and, therefore, the weight of the shade.

While the operating system could be used with any vertically movable shade, it is described in connection with a collapsible fabric that extends between the top rail and the bottom rail and extends across the architectural opening when the covering is extended but can be retracted into a neat stack adjacent the top rail when the covering is fully retracted.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric of a retractable covering shown in a fully extended position and incorporating the operating system of the present invention.

FIG. 2 is an isometric similar to FIG. 1 with the covering in a fully retracted position.

FIG. 3 is a left end elevation of the covering as shown in FIG. 2.

FIG. 4A is an enlarged fragmentary section taken along line 4A-4A of FIG. 1.

FIG. 4B is a section similar to FIG. 4A with the mounting structure for the guide pins shown in an alternative position.

FIG. 4C is an enlarged section taken along line 4C-4C of FIG. 4A.

FIG. 5A is an exploded isometric of the bottom rail of the covering of the present invention showing the operative components of the system therein.

FIG. 5B is an exploded isometric of the top rail of the covering of the present invention with the collapsible fabric shown therewith.

FIG. 6 is an exploded isometric of the operating system incorporated in the bottom rail.

FIG. 7 is an enlarged fragmentary vertical section taken along line 7-7 of FIG. 1 through the top rail with the collapsible fabric in an extended position.

FIG. 8 is a vertical fragmentary section similar to FIG. 7 with the collapsible fabric in a fully retracted position.

FIG. 9 is a fragmentary vertical section taken through the top rail illustrating the connection of lift cords through the top rail.

FIG. 10 is a fragmentary vertical section similar to FIG. 9 with the connection system in a locking position.

FIG. 11 is an enlarged vertical section taken along line 11-11 of FIG. 1.

FIG. 12 is a section similar to FIG. 11 with the mounting bracket partially released.

FIG. 13 is a fragmentary section taken along line 13-13 of FIG. 11.

FIG. 14 is an exploded view of the two component mounting bracket for the covering of the present invention.

FIG. 15 is a front elevation of one embodiments of the mounting structure for the guide pins.

FIG. 16 is a front elevation similar to FIG. 15 illustrating a second embodiment of the mounting structure.

FIG. 17 is a front elevation similar to FIGS. 15 and 16 showing still another embodiment of the mounting system for the guide pins.

FIG. 18 is an enlarged fragmentary section taken along line 18-18 of FIG. 1.

FIG. 19 is an enlarged fragmentary section taken along line 19-19 of FIG. 4A.

FIG. 20 is an enlarged fragmentary section taken along line 20-20 of FIG. 4A.

FIG. 21 is a fragmentary section similar to FIG. 20 with the support structure for the guide pins being partially moved from the top frame member of the bottom rail.

FIG. 22 is an enlarged section taken along line 22-22 of FIG. 4A.

FIG. 23 is an isometric of an electrified embodiment of the present invention with the shade shown in a fully closed or extended position.

FIG. 24 is an isometric similar to FIG. 23 with the shade partially retracted illustrating components of the electrical system.

FIG. 24A is an isometric similar to FIG. 24 with the solar cell strip in an alternative position.

FIG. 25 is an isometric of the handle for the dummy vane of the shade of the embodiment of FIG. 23.

FIG. 26 is an enlarged fragmentary isometric showing components of the embodiment as illustrated in FIG. 24.

FIG. 27 is an isometric of the handle from a different direction.

FIG. 28 is an enlarged fragmentary section taken along line 28-28 of FIG. 23.

FIG. 29 is an enlarged fragmentary section taken along line 29-29 of FIG. 26.

FIG. 30 is an enlarged fragmentary section taken along line 30-30 of FIG. 26.

FIG. 31 is an exploded isometric of the handle shown in FIGS. 25 and 27.

FIG. 32 is an isometric showing the motor unit connected to the housing for the wrap spools.

FIG. 33 is an exploded isometric of the component shown in FIG. 32.

FIG. 34 is an isometric of the dummy vane with parts removed for clarity.

FIG. 35 is a fragmentary isometric of the battery pack and a set of batteries positioned in the dummy vane.

### DESCRIPTION OF THE PREFERRED EMBODIMENTS

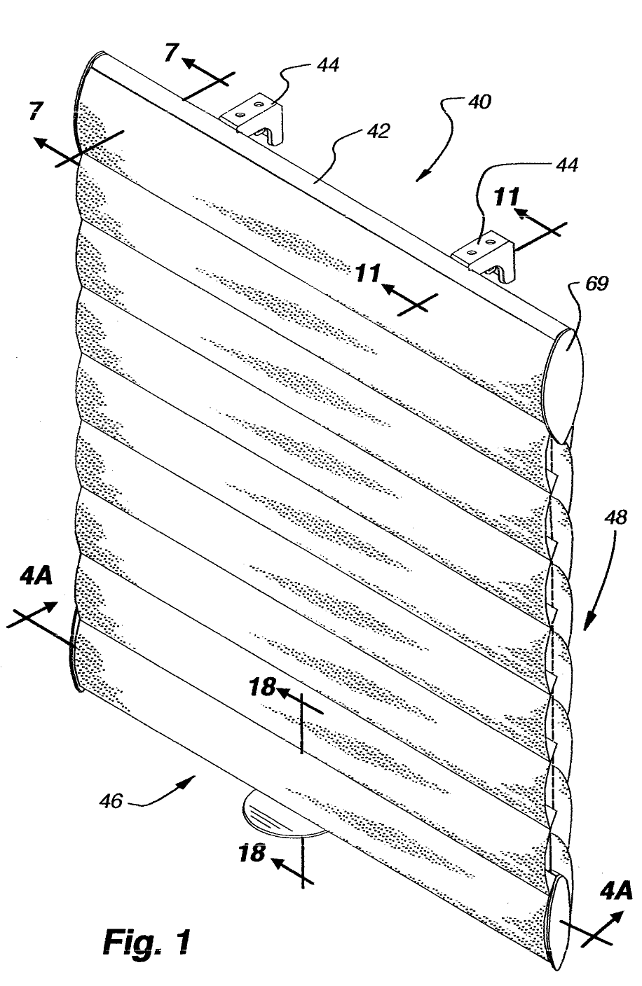

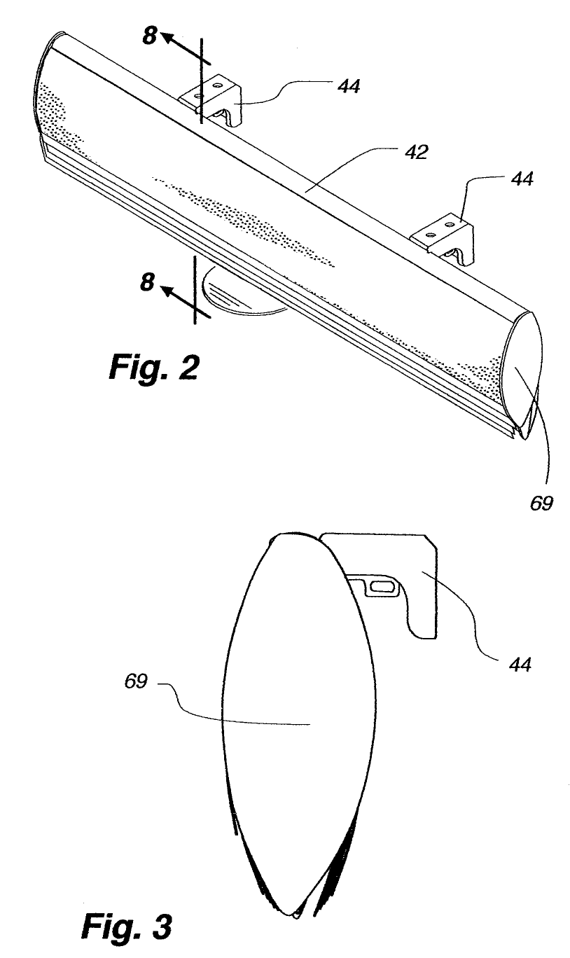

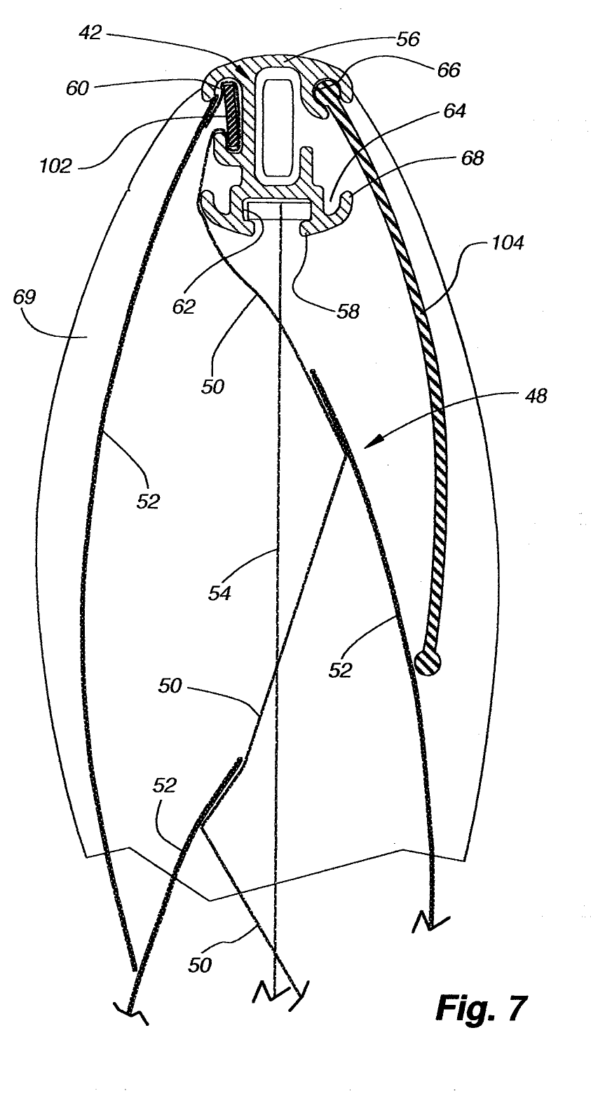

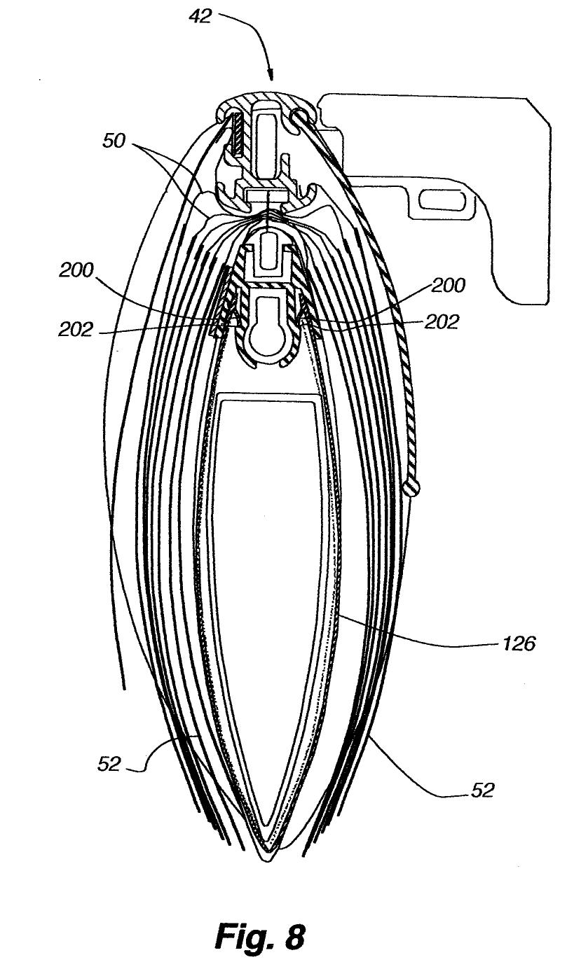

A retractable shade or cover 40 incorporating the operating system of the present invention is show in FIG. 1 to include a top rail 42 supported by mounting brackets 44, a bottom rail 46 housing the operating system of the invention, and a collapsible fabric 48 extending between the top and bottom rails. While the collapsible fabric could be any one of numerous designs, for purposes of the present disclosure, it is probably seen best in FIGS. 1, 5B, 7, and 8 to include a flexible support structure 50 of sheer fabric, support cords or the like suspended from the top rail 42 and to which is attached at vertically spaced locations along horizontal lines of attachment a plurality of semi-rigid transversely arcuate vanes 52. The semi-rigid vanes are alternately attached to the support structure on opposite faces of the support structure and along a top edge of the vane so as to hang freely downwardly from their connection to the support structure on opposite sides of the support structure. FIGS. 1 and 7 show the collapsible fabric 48 extended while FIGS. 2 and 8 show the fabric collapsed in adjacent relationship with the top rail 42 of the covering. In the retracted position, the support structure is gathered adjacent the top rail in a manner to be described later and the vanes are nested relative to each other on front and back sides of the bottom rail 46. A fabric of the type herein disclosed is described in more detail in copending U.S. application Ser. No. 10/581,872, filed Jun. 5, 2006, which application is the Section 371(c) filing of PCT International Application No. PCT/US2004/043043, which is of common ownership with the present application and herein incorporated by reference. A plurality of lift cords 54 extend from the top rail to the bottom rail and are utilized to raise the bottom rail relative to the top rail when retracting the covering. The top end of each lift cord is attached to the top rail while the bottom end is attached to the operating system as will be described in detail hereafter.

The top rail 42 is probably best seen in FIGS. 7, 8, 11 and 12 to comprise an extruded body having a downwardly concave arcuate top wall 56, a downwardly convex arcuate bottom wall 58, a forwardly opening slot 60 in a front wall adjacent the top of the top rail, a downwardly opening slot 62 in the bottom wall, a rearwardly opening slot 64 between a C-shaped groove 66 at the top of the slot and an upwardly projecting lip 68 at the bottom. The slots and grooves in the top rail serve a function to be described hereafter and the top rail is adapted to be mounted on the mounting brackets 44. End caps 69 are inserted into the open ends of the top rail.

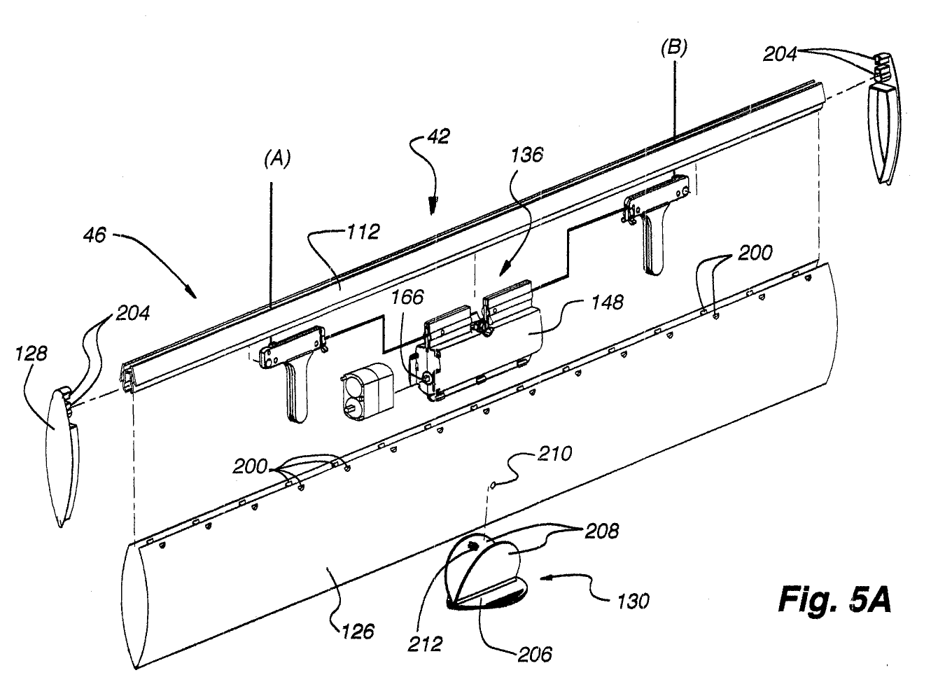

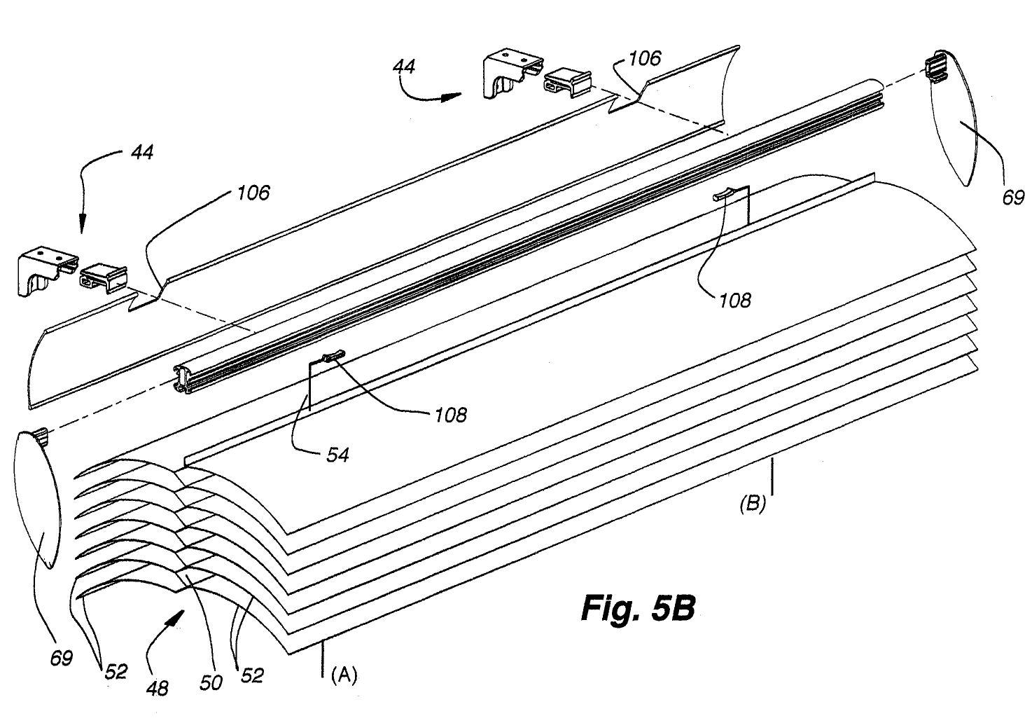

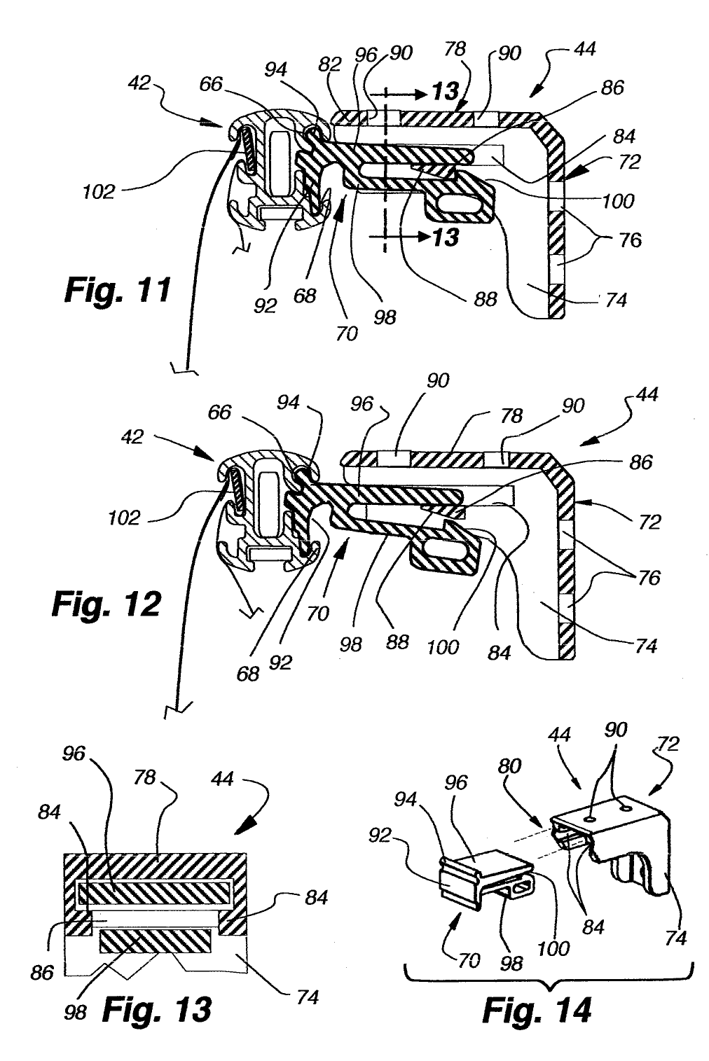

The slot 64 on the rear side of the top rail is adapted to receive a removable component 70 of each mounting bracket 44 so that the top rail can be suspended from the mounting bracket in a forwardly projecting position. Of course, any desired number of mounting brackets can be utilized and connected to the top rail at horizontally spaced locations as shown for example in FIGS. 1 and 5B. The mounting bracket, as best seen in FIGS. 11-14, has a base 72 and the removable component 70. The base is generally L-shaped having a vertical leg 74 with openings 76 for receipt of fasteners (not shown) to secure the base to a vertical surface (not shown) of the framework around an architectural opening and a forwardly projecting horizontal leg 78 defining a forwardly opening horizontal slot 80 between a top wall 82 of the horizontal leg and a pair of shoulders 84. A cross bar 86 with a lower bevel surface 88 bridges the space between the shoulders. The top wall 82 also has openings 90 therethrough for the receipt of fasteners so the mounting bracket can be secured to a horizontal surface of a framework rather than a vertical surface.

The removable component 70 of the mounting bracket 44 has a vertical plate 92 along its front edge with a beaded upper edge 94 adapted to be slid into the C-shaped groove 66 of the top rail 42 with the lower edge of the plate being received behind the lip 68 of the rearwardly facing slot 64 of the top rail. In this manner, the removable component is slidably but positively secured to the top rail at any location along the length of the top rail. The removable component is made of a semi-rigid material such as a suitable plastic and includes an upper horizontal plate 96 adapted to be received in the horizontal slot 80 of the base and a flexible lower arm 98 having a bevel surface 100 adapted to engage the bevel surface 88 of the cross bar 86 in the base so that the flexible lower arm can be flexed as seen in FIG. 12 when the removable component is inserted into or removed from the base. Once the removable component is fully inserted into the base, the bevel surface 100 of the lower arm catches behind the cross bar 86 to releasably connect the removable component to the base. Of course, to remove the removable component from the base, the lower arm is simply pulled or flexed downwardly and the removable component slid forwardly out of the slot.

As best seen in FIGS. 7 and 8, the forwardly opening slot 60 on the front wall of the top rail 42 is adapted to receive a retention bar 102 around which the support structure 50 for the fabric in the covering is wrapped. The retention bar thereby holds the support structure in the slot 60 so that the collapsible fabric is suspended from the top rail. As will be appreciated, the uppermost vane 52 on the support structure hangs forwardly and thereby blocks most of the top rail from a front view while the remainder of the fabric hangs substantially vertically beneath the top rail.

As best seen in FIGS. 5B and 7, a protective guard 104 of a rigid or semi-rigid material such as plastic is suspended from the C-shaped groove 66 in the rear wall of the top rail 42 and is notched at 106 as seen in FIG. 5B so as not to inhibit connection of the top rail to the mounting brackets. The protective guard is arcuate in nature and extends downwardly from the top rail so as to prevent damage to the fabric 48 when fully retracted as the fabric might otherwise engage the framework for the architectural opening, the mounting bracket or the like.

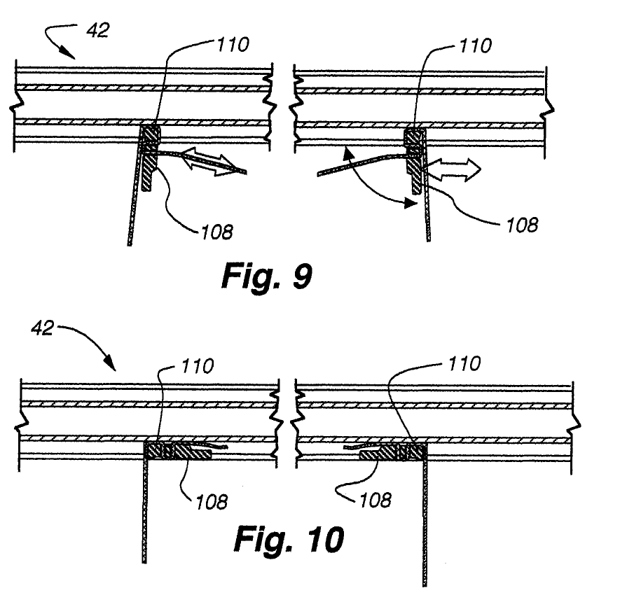

As mentioned previously, the lift cords 54 are provided at spaced intervals along the length of the top rail 42 and the number of lift cords are dependent upon the width of the covering and the consequent weight of the fabric. Each lift cord is anchored in the downwardly opening slot 62 of the top rail as best illustrated in FIGS. 9 and 10. The connection system is identical to that disclosed in detail in applicant's aforenoted copending U.S. application Ser. No. 10/581,872, filed Jun. 5, 2006, which application is the Section 371(c) filing of PCT International Application No. PCT/US2004/043043, which has previously been incorporated by reference. Pivotal lock fingers 108 are slid into the downwardly opening slot in the top rail and the fingers are adapted to be pivoted about the end 110 thereof received in the slot. A lift cord is wrapped about the pivotal end 110 when the finger extends vertically downwardly as shown in FIG. 9 but when the finger is pivoted up into a horizontal position within the downwardly opening slot, the lift cord is pinched between the finger and a wall of the downwardly opening slot to positively anchor the lift cord. Of course, the length of the lift cord, which will ultimately determine the disposition of the covering can be easily adjusted through use of the lock fingers.

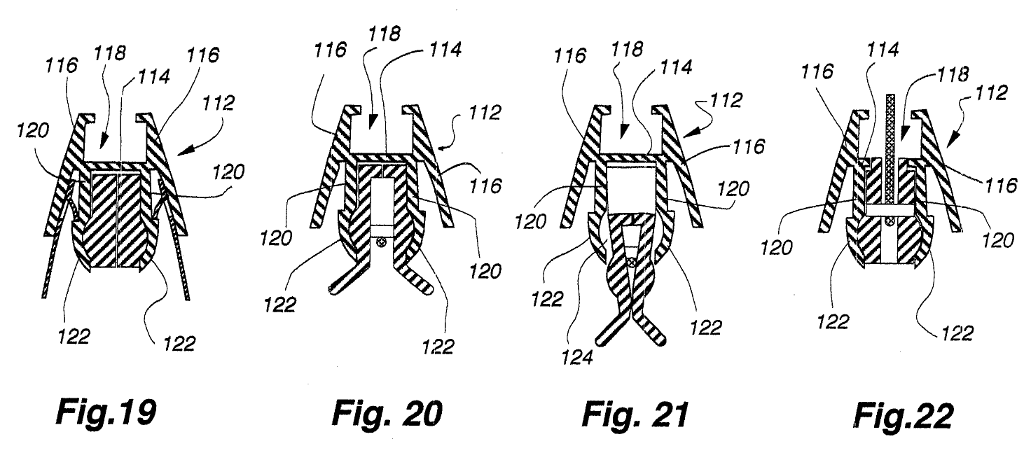

The bottom rail 46 includes an extrusion 112 with the extrusion being of the type described in detail in applicant's aforenoted copending U.S. application Ser. No. 10/581,872, filed Jun. 5, 2006, which application is the Section 371(c) filing of PCT International Application No. PCT/US2004/043043, which was previously incorporated by reference. The extrusion is made of a semi-rigid material which has some flexure but will yieldingly retain its primary configuration probably seen best in FIGS. 19-22. The extrusion includes a horizontal base 114 having upwardly convergent forward and rearward plates 116 defining an open groove 118 in the top of the extrusion and downwardly depending legs 120 with the legs having confronting concave surfaces 122 at their lower ends. A space 124 is defined between the legs for receipt of components to be described hereafter.

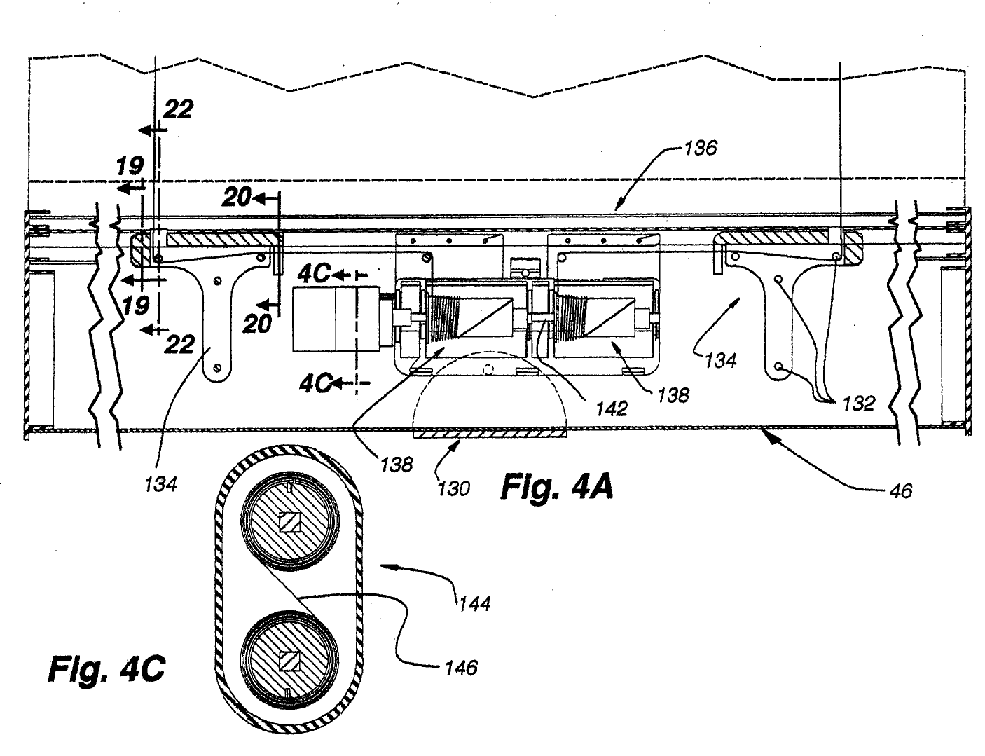

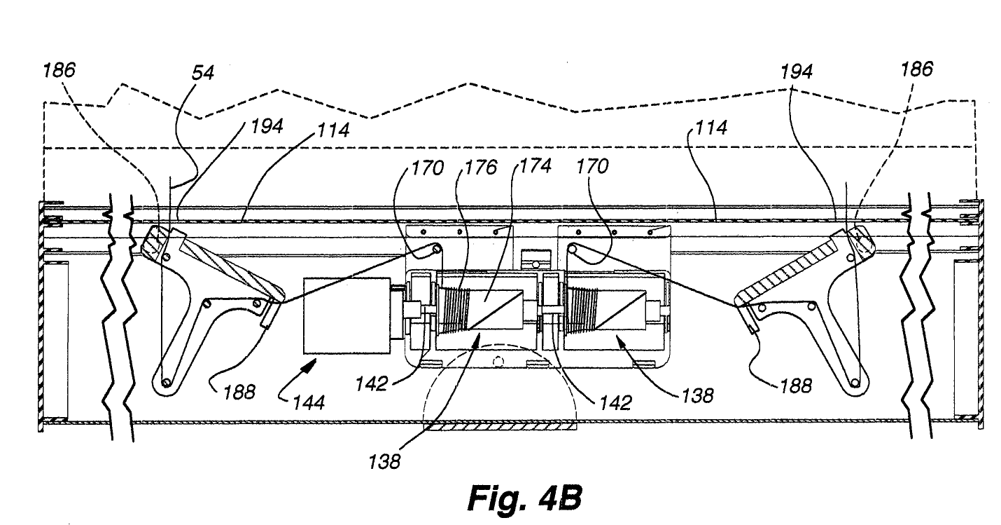

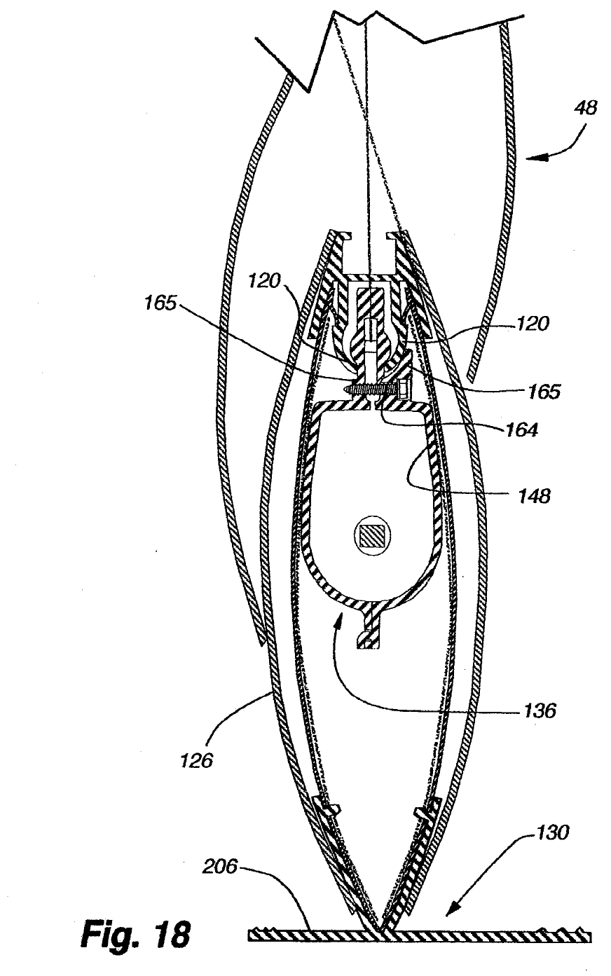

The components for the operating system of the invention are suspended from the extrusion 112 and confined within an outer cover 126 of the bottom rail as shown in FIG. 18 that simulates two confronting vanes of the collapsible fabric. The extrusion and outer cover with end caps 128 and a handle 130 for movement of the covering constitute the bottom rail 46 or a dummy vane at the bottom of the covering. The components of the operative system suspended from the extrusion 112 within the bottom rail or dummy vane are designed to control the lift cords 54 so that the effective length of the lift cords can be shortened or lengthened depending upon the desired position of the shade. The components in the dummy vane are designed to counterbalance the weight of the covering 40 so that it can be removably positioned at any location between fully extended and retracted positions. As best seen in FIG. 4A, the operating components suspended from the extrusion include a plurality of guide pins 132 on mounting supports 134 with the mounting supports being pivotally suspended from the depending legs 120 of the extrusion and a spring-controlled cord gathering system 136 which is mounted at or near the longitudinal center of the extrusion.

Looking first at the cord gathering system 136, as best shown in FIG. 4B, it will be seen to have two horizontally disposed wrap spools 138 which are generally cylindrical having a non-circular axial passage 140 therethrough for receipt of a complementary non-circular drive shaft 142. The drive shaft is operatively connected to a modular spring unit 144 (FIG. 4C) having a constant tension spring 146 mounted so as to not only counterbalance the weight of the covering, but also to bias the drive shaft 142 in a direction that would cause the lift cords 54 to wrap around the wrap spools 138.

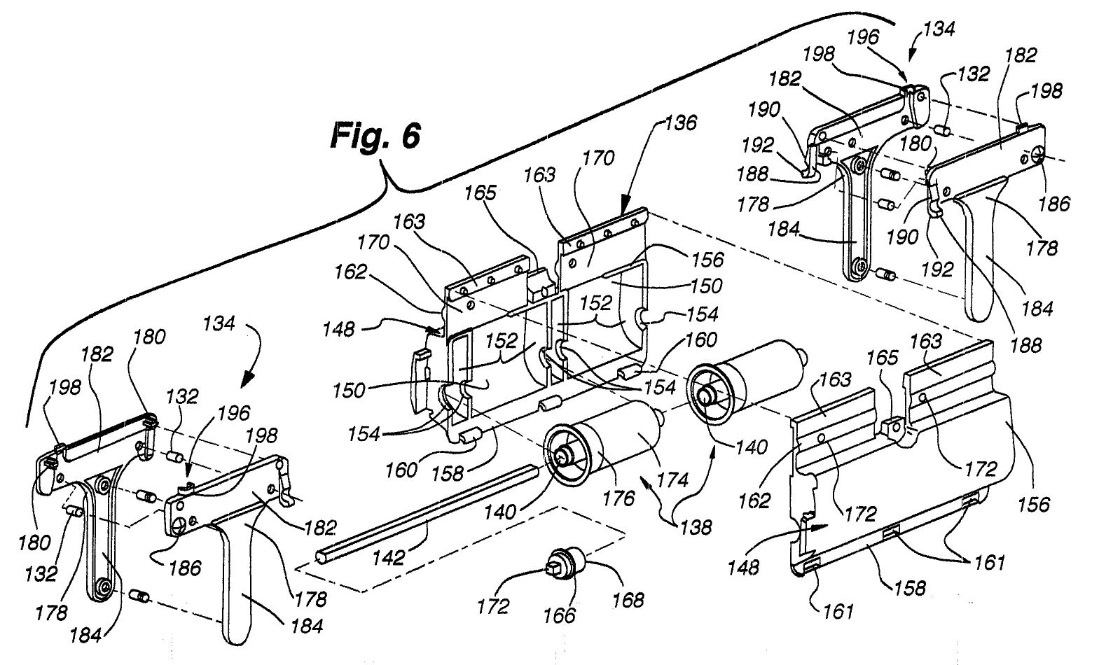

The wrap spools 138 and drive shaft 142 are confined within a two-piece gathering system housing 148 shown in FIG. 6 which has two arcuate chambers 150 in which the wrap spools are disposed. The chambers are also defined by vertical walls 152 having arcuate notches 154 therein for rotative support of the drive shaft. The lower edges of the housing halves 156 have connectors for releasably securing the two halves together while the upper edges have confronting flanges 158 with one flange having a plurality of projecting hooks 160 and the opposite half having complementary catches 161 so that when the upper halves are positioned in confronting engagement, the hooks 160 are received on the catches to releasably hold the halves in confronting relationship with the closed chambers 150 for rotative support of the wrap spools 138. The upper flange 163 on each half has an outwardly directed horizontal bead 162 so that when the halves are in confronting relationship, the flange 163 can be inserted into the space 124 between the depending legs of the extrusion as possibly seen best in FIG. 18 with the beads 162 on the flanges projecting outwardly into the confronting concave lower ends 122 of the depending legs so that the housing is slidably and releasably suspended from the extrusion 112. As also seen in FIG. 18 each housing half 156 has a raised finger 165 (one longer than the other) in a gap in the associated flange 163 so that, a fastener 164 can be passed through the raised fingers to draw them together whereby they engage and pinch the depending legs 120 therebetween to positively position the housing 148 on the extrusion 112 to prevent the housing from sliding along the protrusion. The housing serves as a ballast and can be positively positioned at any desired location along the length of the extrusion. The positioning of the housing thereby allows an adjustment in the covering to assure the covering will hang smoothly with the bottom rail 46 disposed horizontally.

As best appreciated by reference to FIGS. 5A and 6, the drive shaft 142 protrudes from the left end of the housing 148 and receives a connector 166 having a socket 168 configured to receive for unitary rotation the end of the drive shaft and a square stub shaft 172 projecting from its opposite end. The connector thereby rotates with the drive shaft and the square stub shaft is adapted to be received in the modular spring unit 144 so as to coil and uncoil the spring 146 depending upon the direction of rotation of the drive shaft. The coil spring unit is a conventional unit and is of the type also described in applicant's U.S. Pat. No. 7,063,122 B2, which is hereby incorporated by reference.

A horizontal space 170 is defined between the upper flanges 163 of the housing halves 156 when they are connected and a pair of horizontal pins 172 (FIG. 4B) extend between the halves so as to bridge the space between the flanges. The pins 172 are vertically aligned with one end of an associated wrap spool 138 and as will be described hereafter, a lift cord 54 is adapted to be passed around the pin 172 and downwardly onto the associated wrap spool. The pins 172 are aligned with the left end of each wrap spool and it can be seen that the main body 174 of each wrap spool is generally cylindrical except at its left end 176 where it is frustoconical in configuration defining a sloped outer surface converging to the right and into the cylindrical surface of the wrap spool. As possibly best appreciated by reference to FIGS. 4A and 4B, as lift cord is fed to an associated spool and the spool is rotated in a wrapping direction, the cord is wrapped at a relatively large diameter and each additional wrap forces a previous wrap down the sloped frustoconical surface 176 into a smaller diameter and therefore a looser wrap on the wrap spool so that cord can be wrapped and forced to the right with each successive wrap without entanglement of the cord. Of course, when the wrap spools are rotated in an unwrapping direction, the lift cord is removed therefrom in a reverse direction.

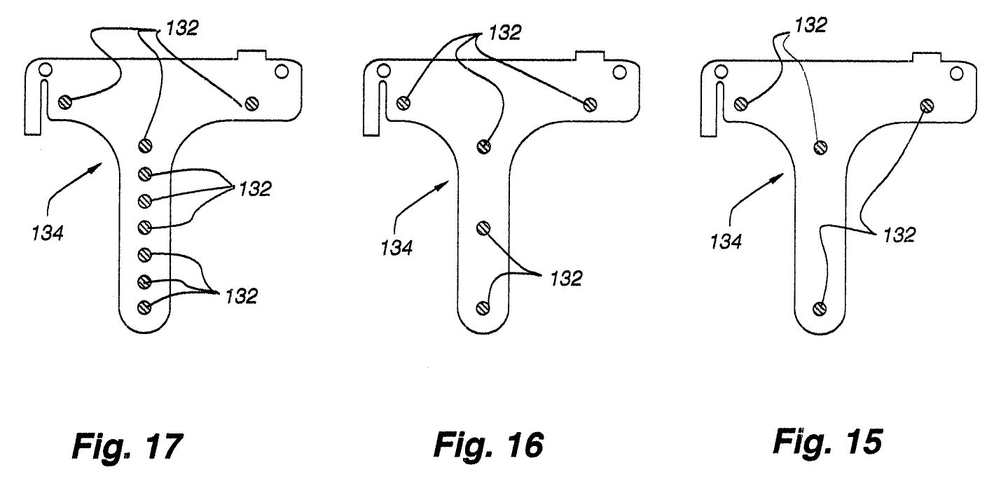

Before the lift cord 54 is passed into the housing for the wrap spools, however, it is passed through the guide pin mounting support or structure 134 where the lift cord is passed in a predetermined possibly circuitous path around a predetermined number of the guide pins 132 which provide frictional resistance to sliding movement of an associated lift cord 54. With reference to FIGS. 4A, 4B, 6, and 15, it will be seen that each mounting structure also has two halves 178 which are interconnectable in face-to-face relationship and are generally of T-shaped configuration. A plurality of guide pins 132 are anchored in one of the T-halves 178 so as to project toward the opposite T-half where it is received in a complementary recess (not seen) so that the pins 132 bridge the space between the T-halves. Connection pins 180 are positioned at each end along the top edge of the horizontal leg 182 of one T-half and these pins serve to connect the top edge of each T-half to the other. The T-shaped support structures 134 are made of a semi-rigid material such as plastic which has some flexure so even though they are secured together along their top edge, the bottom or vertical legs 184 of the T-halves can be separated for purposes of threading a lift cord through the mounting structure.

At one end of the horizontal leg 182 of a T-half 178 and on an outside face thereof, a generally hemispherical bead 186 is provided which is adapted to be pivotally inserted into the space 124 between the depending legs 120 of the extrusion 112 so as to be within the confronting concave lower edges 122 of the depending legs. This connection allows the T-shaped mounting support 134 to be pivoted between the positions of FIGS. 4A and 4B for a purpose to be described later. At the opposite end of the horizontal leg 182 of each T-shaped half is a pivotal finger 188 having a bead 190 formed near its top and a finger gripping portion 192 at its bottom. The bead at its top is also adapted to be received in the space 124 between the depending legs of the extrusion as seen in FIG. 20 so as to project into the space between the curved confronting concave portions of the legs but by squeezing the fingers toward each other, the beads on the fingers can be removed from the space between the depending legs as seen in FIG. 21.

With reference to FIGS. 4A and 4B, it can be seen that each lift cord 54 extends vertically through a hole 194 in the horizontal base 114 of the extrusion 112 for sliding movement therethrough. The hole and thus the lift cord is aligned with one end of a mounting structure 134 adjacent the pivotal hemispherical bead 186. The lift cord enters the space between the T-shaped halves through an opening 196 defined between two vertically directed semi-cylindrical bodies 198 best seen in FIG. 6 with that opening being aligned with one of the guide pins 132 formed on the T-shaped support structure. As will be appreciated from the description hereafter, any number of guide pins 132 can be provided depending upon the height and width and thus the weight of the covering 40 but a first embodiment is shown in FIGS. 4A, 4B, 6 and 15 wherein there are a pair of horizontally spaced guide pins on the horizontal leg 182 of the mounting structure 134 and a pair of guide pins on the vertical leg 184 of the mounting structure. The lift cord can be passed around these guide pins in various manners such as shown in FIG. 4A or 4B. Obviously, the more pins the lift cord passes around the more frictional resistance there is to the sliding passage of a lift cord through the mounting structure thus giving more assistance to controlling the weight of the shade so that it can be counterbalanced and removably positioned at any location between fully extended and fully retracted positions.

FIG. 16 shows a second embodiment wherein there are three vertically aligned guide pins 132 in the vertical leg 184 with FIG. 17 showing still a further embodiment where there are seven vertically aligned pins 132 in the vertical leg with each of the alternative embodiments having the two horizontally spaced guide pins 132 in the horizontal leg 182.

As mentioned previously, the T-shaped mounting structures 134 are pivotally suspended from the extrusion 112 to facilitate threading of a lift cord 54 through the mounting structure. It has been found to be convenient to pivot the end of the horizontal 182 leg having the pivotal finger 188 thereon downwardly to provide adequate spacing from the extrusion so an operator can easily thread the lift cord through the T-shaped mounting structure. Once it has been threaded, it can be pivoted from the threading position of FIG. 4B to the operative position of FIG. 4A and snapped in place as described previously.

In operation of the covering, with the lift cords 54 threaded as illustrated in either FIG. 4A or FIG. 4B, it will be appreciated that when the covering is moved from the fully retracted position of FIG. 2 to the fully extended position of FIG. 1, the lift cords are caused to be unwrapped from their associated wrap spools 138 and rotation of the wrap spools condition the operatively connected coil springs 146 to maintain a bias on the wrap spools in an opposite direction. The coil springs thus have a role in supporting the shade at any position between the fully extended and retracted positions but the friction of the lift cords as they pass around the guide pins 132 further helps in supporting the shade at any location. The guide pins provide a fine tuning system for regulating the amount of support provided by the mounting system depending upon the weight of the shade which is normally determined by the height and width of the shade.

As mentioned previously, the extrusion 112 supports an outer plastic shield or body 126 of a configuration simulating a pair of confronting vanes of the collapsible fabric so as to form the bottom rail or dummy vane. Such an arrangement is also shown and described in detail in the afore-mentioned copending U.S. application Ser. No. 10/581,872, filed Jun. 5, 2006, which application is the Section 371(c) filing of PCT International Application No. PCT/US2004/043043. The top edge of the shield 126 has barbs 200 (FIG. 8) adapted to be supported on shoulders 202 defined on the outer surface of each depending leg 120 of the extrusion 112 and the upper edges of the sides of the protective cover are inserted into a space between the flared side walls 116 of the extrusion and the depending legs 120.

With reference to FIG. 5A, the end caps 128 are of the same cross-sectional configuration as the protective cover 126 and can be inserted into the open ends of the cover. The end caps have inwardly protruding pins 204 received in the open ends of the extrusion 112 to further secure and support the protective body. The handle 130 is attached to the bottom edge of the protective cover at the longitudinal center thereof with the handle having a bottom generally circular plate-like portion 206 of a predetermined thickness for example 1/16 of an inch and two upwardly flared ears 208 between which the protective body can be inserted. Openings 210 extend through the protective body for receipt of connector pins 212 on the ears so that the handle is positively secured to the protective body and in a position to raise or lower the dummy vane 46 and thus the extrusion 112. The thickness of the bottom plate of the handle establishes a predetermined spacing between the dummy vane and a window sill for example so that the spacing is uniform when the covering is fully extended.

From the above, it will be appreciated that an operating system for a retractable vertically movable covering for architectural openings has been described which reliably allows the shade to be removably positioned at any location between a fully retracted position adjacent the top rail and a fully extended position wherein the fabric extends across an architectural opening.

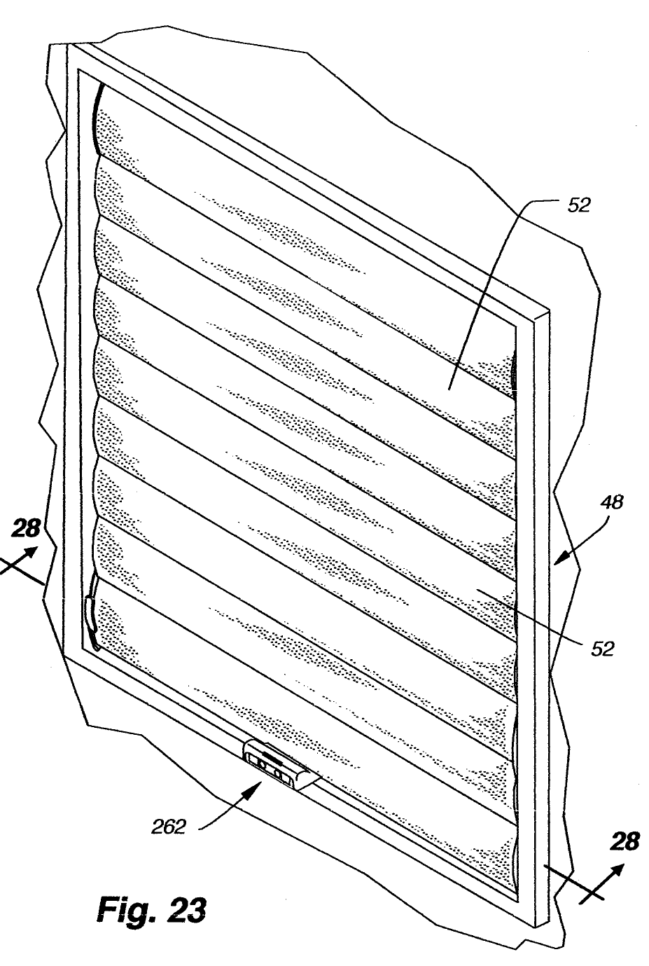

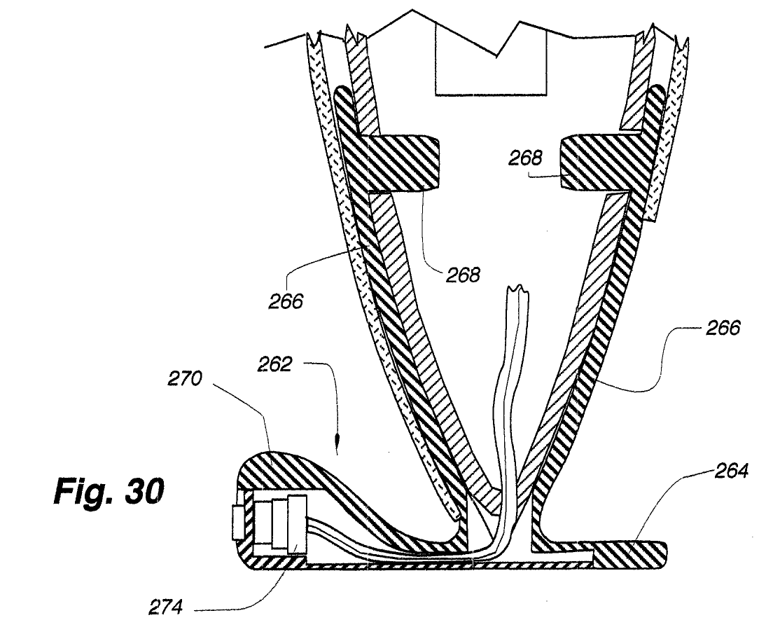

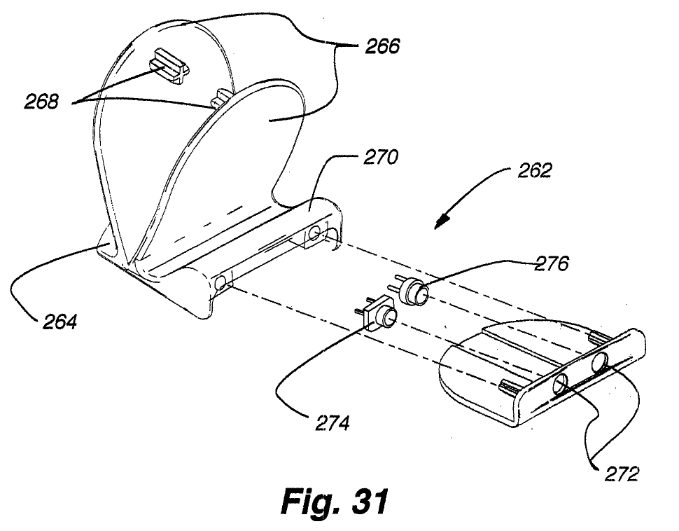

An alternative motorized embodiment of the covering is shown in FIGS. 23-35. As can be appreciated by reference to FIG. 23, the structural components of the shade are identical to that previously described with the only modification being in the fact that a solar powered motor 214 is used to operate the shade rather than being operated through the lift handle and coil springs. As will be described in more detail hereafter, the motorized embodiment of the invention utilizes solar cells for generating DC current which is delivered through appropriate circuitry to a motor for driving the drive shaft of the wrap spools in lieu of the springs of the first described embodiment.

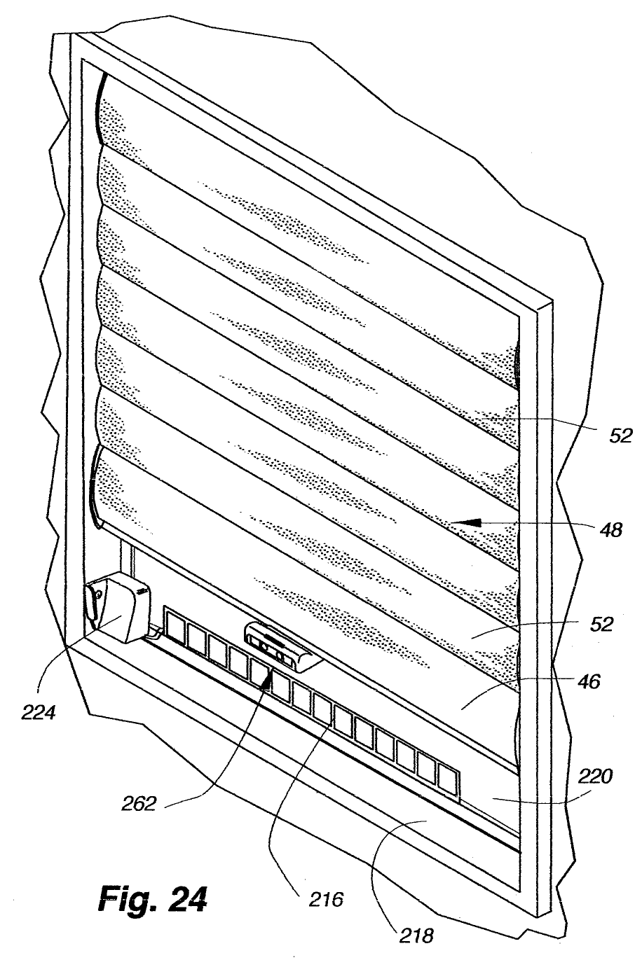

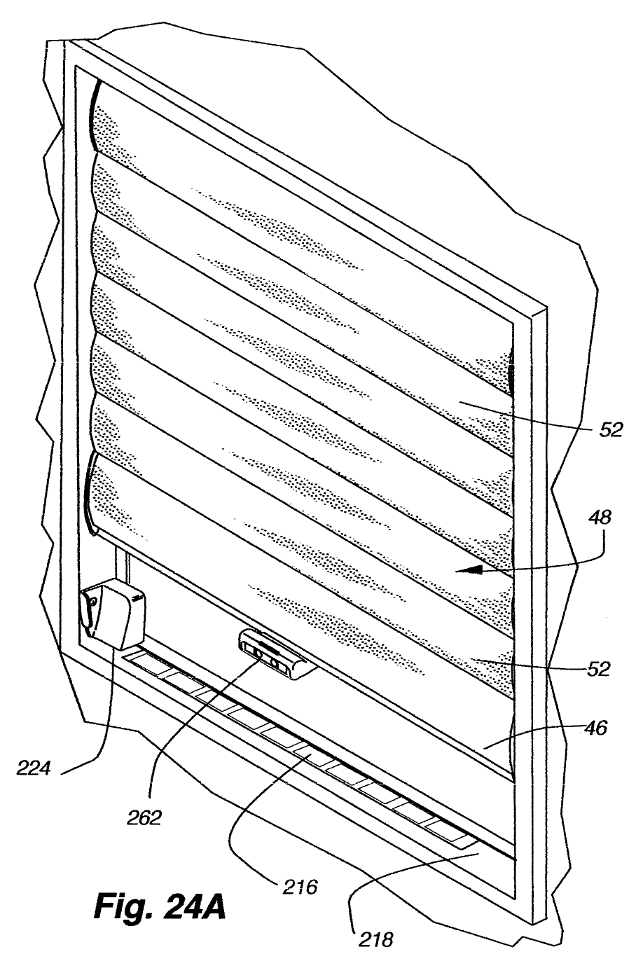

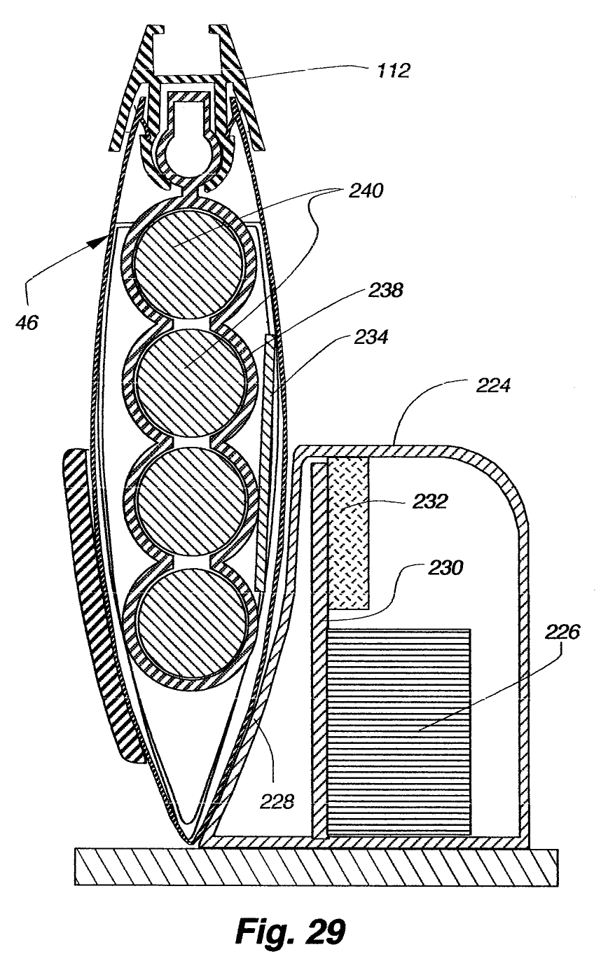

With reference to FIGS. 24 and 24A, a conventional strip 216 of solar cells is laid either across the sill 218 (FIG. 24A) for the architectural opening or if there is a glass panel 220 or the like in the opening, the strip of solar cells can be attached to that panel as shown in FIG. 24. As possibly best seen in FIG. 26, the output from the strip of solar cells is fed through electrical wiring 222 into an induction housing 224 having a control circuit 226 (FIG. 29). The induction housing is seen anchored to the frame for the architectural opening and includes a cradle 228 in which the dummy vane 46 can be seated. There is an induction housing 224 at both sides of the architectural opening so as to receive and cradle both ends of the dummy vane.

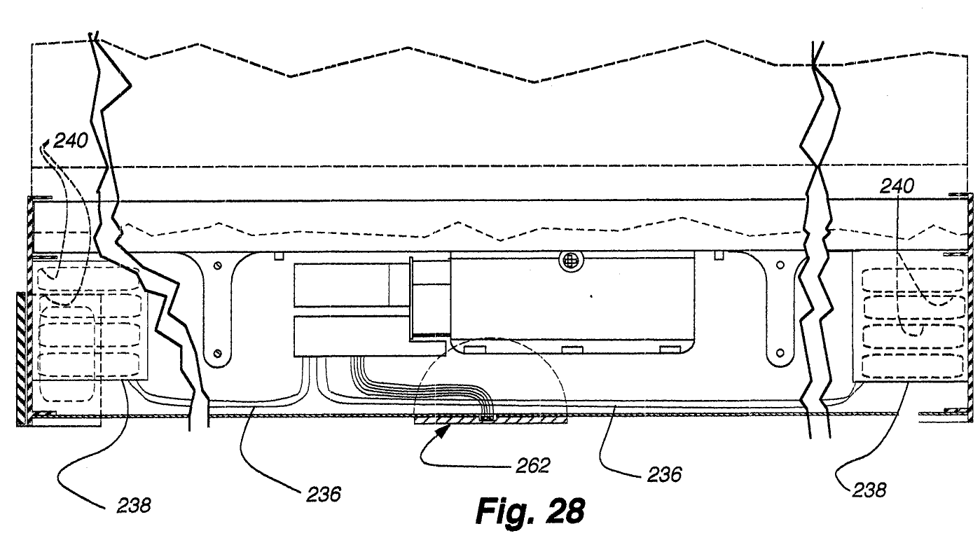

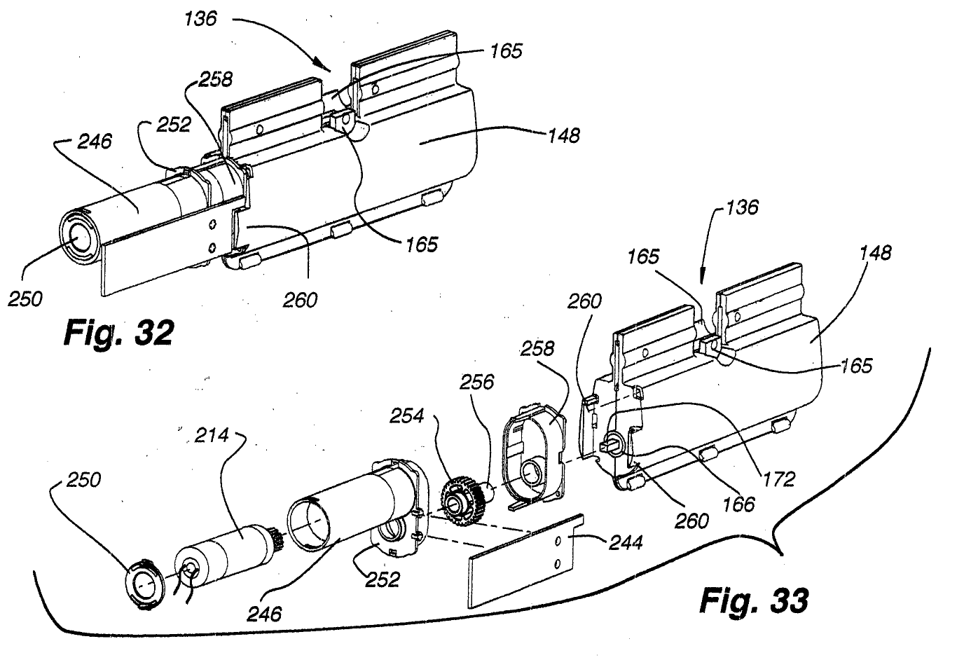

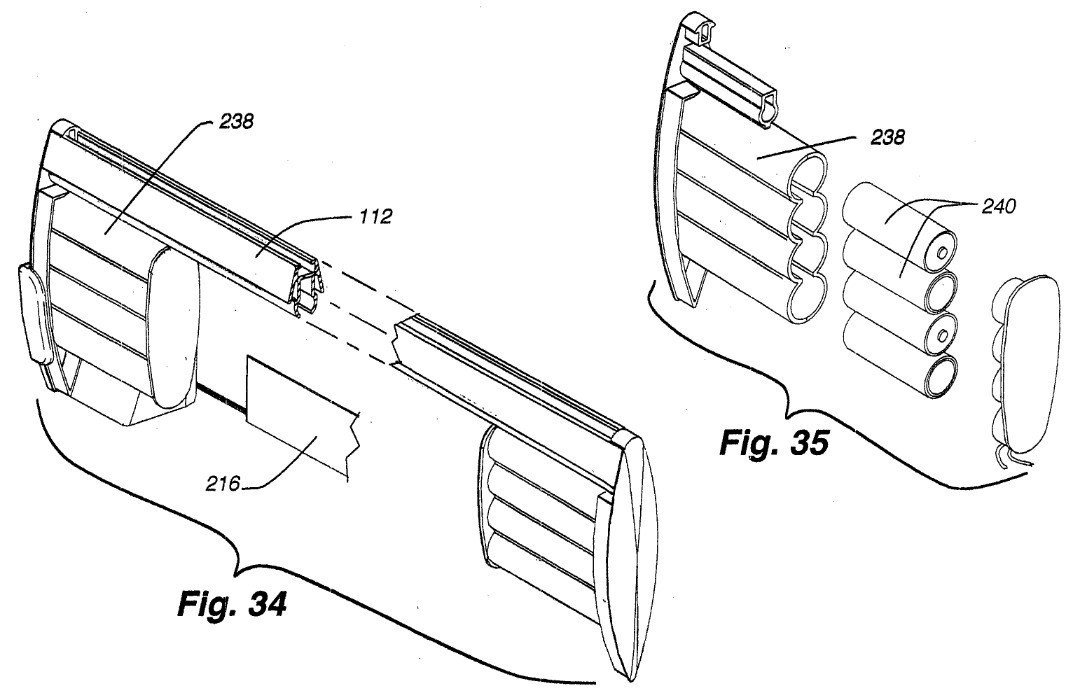

With reference to FIG. 29, the induction housing 224 includes the control circuit 226 for converting the DC current to AC current which is transmitted through a circuit board 230 to an AC transmitting circuit 232 which induces the AC current into a receiving circuit board 234 disposed within the dummy vane 46 at the bottom of the cover. The receiving circuit board 234 converts the AC current it receives back to DC current which is transmitted through appropriate wiring 236 (FIG. 28) to battery packs 238 in opposite ends of the dummy vane. Each battery pack, as possibly best appreciated by reference to FIGS. 34 and 35, receives four rechargeable batteries 240 with the DC current received at each battery pack being used to recharge the batteries. The battery packs are suspended from the extrusion 112. DC current from the battery packs is transmitted via appropriate wiring 242 to a control circuit board 244 mounted on a motor housing 244 as best viewed in FIGS. 32 and 33. The control circuit board is electrically connected to the motor 214 positioned within the motor housing for energizing and de-energizing the motor. The motor is held within the motor housing by a cap 250.

The motor housing 246 has a mounting plate 252 which not only supports the control circuit board 244 but also rotatably supports a gear 254 forming a transmission so that the rotational speed from the output of the motor is appropriately geared down through a predetermined mechanical advantage for output through a gear shaft 256. The gear and the motor housing are mounted in a motor mount 258 with the gear being rotatably seated in a bearing within the motor mount and drivingly engaged with the square stub shaft 172 on the connector 166 described previously. It therefore will be appreciated that solar energy absorbed by the solar cells is transmitted to the motor for selective rotation of the drive shaft which drives the wrap spools 138 in either desired direction.

The housing 148 for the wrap spools 138 has flexible attachment fingers 260 that releasably grip the motor mount 258 or the spring unit 144, as the case may be, so that the system is modularized and can be converted between a manually operated system as described in connection with the first embodiment and a motorized system.

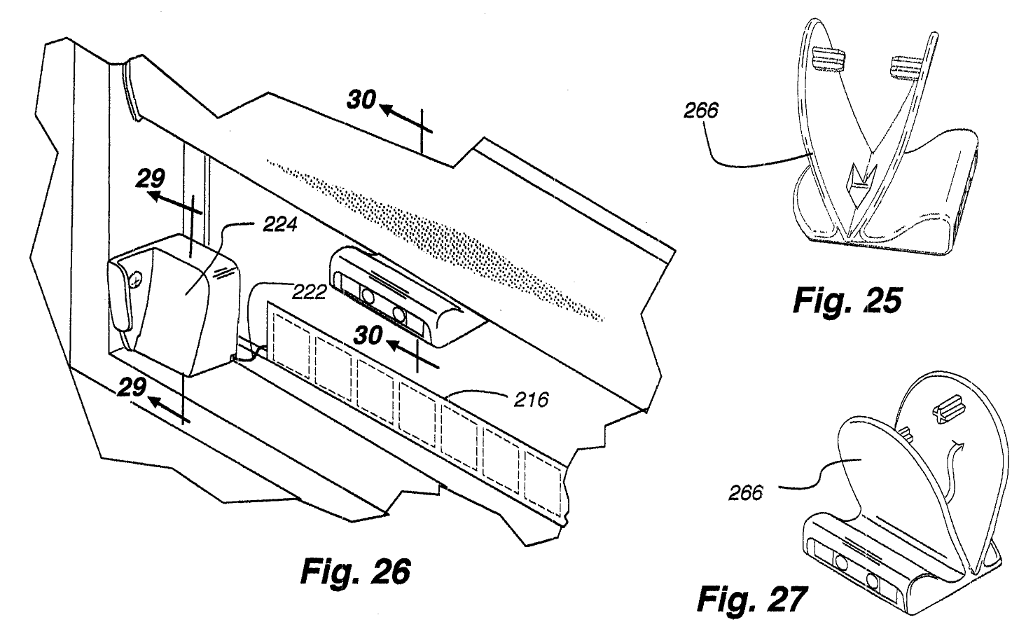

The handle 262 mounted on the bottom edge of the dummy vane 46 in the motorized embodiment is shown best in FIGS. 25-27, 30 and 31 to again have a base 264 and a pair of upstanding ears 266 which are connected to the dummy vane with support pins 268. The base in the motorized embodiment, however, has a raised forward edge 270 having a pair of openings 272 for receipt of a push button switch 274 and an infrared sensor 276. Wiring from the push button switch and infrared sensor pass to the electric motor 214 as seen in FIG. 28. The push button switch can be depressed manually to cause the motor to run in either direction to raise or lower the covering. The infrared sensor can be used to cooperate with a remote controller that also drives the motor in one direction or the other depending upon the direction of movement desired for the covering.

Pursuant to the above, it will be appreciated the operating system for the collapsible covering is seen to be modularized so that it can be manually operated or motor driven either by a touch of a finger or remotely. In either event, the control system is all mounted in the dummy vane at the lower end of the covering so that no headrail is required for the covering.

Although the present invention has been described with a certain degree of particularity, it is understood the present disclosure has been made by way of example and changes in detail or structure may be made without departing from the spirit of the invention as defined in the appended claims.

1. A covering for an architectural opening movable between extended and retracted positions comprising in combination:
a top rail,
a collapsible fabric suspended from said top rail,
a bottom rail suspended from said top rail by a plurality of lift cords,
at least one spool about which said lift cords can be wrapped in said retracted position, and
a counterbalance system operatively connected to said spools for releasably supporting said fabric at a plurality of intermediate positions between said extended and retracted positions, said system including at least one pin about which said lift cords are wrapped.

2. The covering of claim 1 wherein said system further includes a spring for carrying at least a portion of the weight of said fabric.

3. The covering of claim 1 wherein said system further includes a motor for moving said covering between said extended and retracted position and for supporting at least a portion of the weight of said fabric.

4. The covering of claim 1 wherein there are a plurality of said pins.

5. The covering of claim 4 wherein there are a plurality of said pins associated with each lift cord.

6. The covering of claim 1, 2 or 3 wherein said fabric includes a flexible support structure and a plurality of vanes flexibly connected to said support structure, said support structure being gathered and said vanes being stacked in said retracted position.

7. The covering of claim 6 wherein said vanes are alternatively connected on opposite sides of said support structure.

8. The covering of claim 3 further including a remote control for said motor.

9. The covering of claim 2 wherein said spring is a coil spring.

10. The covering of claim 9 wherein there are a plurality of said springs connected in series.
